(19) United States
(12) Patent Application Publication
(10) Pub. No.: US 2008/0011838 A1
(43) Pub. Date: Jan. 17, 2008

(54) ROTATABLE POINT-OF-SERVICE TERMINAL

(75) Inventor: Chris Henry, Phoenix, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: HYPERCOM CORPORATION, Phoenix, AZ (US)

(21) Appl. No.: 11/736,459

(22) Filed: Apr. 17, 2007

Related U.S. Application Data
(60) Provisional application No. 60/792,824, filed on Apr. 17, 2006.

(51) Int. Cl. G07G 1/14

(52) U.S. Cl. 235/383

(57) ABSTRACT

The present invention provides for a rotatable, portable POS terminal through the use of software and hardware that supports different screen orientations for electronic signature capture. The POS terminal also accommodates contactless instrument readers and optionally includes features for user display interaction, multi-tasking capabilities, check reading and age and identity verification.

### CROSS-REFERENCE TO RELATED APPLICATION

This application claims priority to and benefit of U.S. Provisional Application No. 60/792,824, entitled “Rotatable Point-of-Sale Terminal” and filed on Apr. 17, 2006, which is hereby incorporated by reference in its entirety

### FIELD OF INVENTION

The present invention relates, generally, to point of service (“POS”) terminals, and more particularly to a rotatable POS terminal.

### BACKGROUND OF THE INVENTION

Point of service (“POS”) terminals enable convenient electronic payment for many products and services. Consumers holding cards associated with a charge, credit, debit, or loyalty account may pay for a purchase simply by using the card with a POS terminal located at stores, restaurants, and other locations where the products and services are being purchased. Before completion of many types of transactions (e.g., credit card transaction), the cardholder will have to sign a receipt that signifies their authorization of the transaction. Often, this signature is performed electronically, wherein the cardholder signs an electronic receipt using a stylus or other pointing device on the display of the POS terminal.

However, the limitation of the screen size of the POS terminal, especially of a smaller POS terminal, can make it difficult to either display all of the necessary information or for the cardholder to apply their signature. Accordingly, it is desirable to create a compact, portable POS terminal that may provide different screen sizes for capturing the cardholder's signature.

### SUMMARY OF THE INVENTION

The present invention facilitates a rotatable, hand-held POS terminal that supports different screen orientations. The POS terminal utilizes software and hardware that supports rotating the POS terminal 90 degrees such that electronic signature capture can be performed with a landscape screen orientation, while the remainder of the displays for the POS terminals can take place with a portrait screen orientation. By utilizing software that supports rotating the POS terminal, a POS terminal may be produced that is compact, and yet capable of capturing electronic signatures in a landscape format so that there is more room for the cardholder to sign their signature. When the POS terminal is in operation, displays can take place in a portrait orientation, and when it is time to perform electronic signature capture, the POS terminal can be rotated 90 degrees such that there is more display space to capture signatures.

Other features of various embodiments of the present invention may include or support an interactive screen, multi-tasking capabilities, age and identity verification, program or account enrollment, account status and balance inquiries, payroll and government check reading, and medical or other insurance claim transactions. The present invention may be used with various types of accounts including credit, debit, charge, and loyalty programs and may also accommodate payment by promotion or gift cards, prepaid cards, payroll checks and government checks.

### BRIEF DESCRIPTION OF THE DRAWINGS

Additional aspects of the present invention will become evident upon reviewing the non-limiting embodiments described in the specification and the claims taken in conjunction with the accompanying figures, wherein like reference numerals denote like elements, and

FIG. 1 is a perspective view of an exemplary POS terminal according to one embodiment of the present invention;

FIG. 2 is a top view of the exemplary POS terminal of FIG. 1; and

FIG. 3 is a side view of the exemplary POS terminal of FIG. 1.

### DETAILED DESCRIPTION

The detailed description of exemplary embodiments of the invention herein makes reference to the accompanying drawings, which show exemplary embodiments by way of illustration and the best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the system (and components of the individual operating components of the system) may not be described in detail herein. It should be noted that many alternative or additional functional relationships or physical connections may be present in a practical system.

A point of sale (“POS”) terminal according to various embodiments of the present invention includes a card reader, a printer, various electronic circuits for processing a financial transaction, a display for presenting and optionally receiving input of transaction information, a keypad including numeric and function keys, and a housing containing the circuits, display and keypad. The printer may be housed within the POS terminal or the printer may be housed external to the POS terminal. The POS terminal may also be used with a contactless card reader, bar card reader, biometric reader, or other input devices, and thus may provide for a variety of interfaces. Wireless capabilities may also be incorporated into the present invention to promote portability. Other periphery devices for use with the POS terminal may include additional displays, PIN entry pads, alphanumeric keyboards, voice prompt systems, and signature capture devices. The POS terminal may be a stand alone unit or may be integrated into an electronic cash register (“ECR”), vending machine or a self check-out kiosk and the like.

In an exemplary POS transaction, the POS terminal facilitates payments by extracting account information from a user's transaction instrument (e.g., when a user swipes a credit card or inserts a smart card), receiving authentication input, constructing an authorization message, and communicating the authorization message to a host computer to authorize a financial transaction. As used herein, the term “user” includes a consumer, cardholder, merchant, and merchant temporarily in possession of a consumer's transaction card. Cardholder authentication may be accomplished using a PIN number, signature, voice command, biometric input, encrypted transaction instrument data, or any other suitable input. The host computer performs normal authorization procedures and returns one of an authorization and a rejection message. In performing an “on-line” transaction, after the transaction is consummated, the POS terminal communicates the relevant details of the transaction to be stored on the host computer system. While in performing an “off-Line” transaction, the terminal may approve or decline based on tables or card date or other data, and later forward transaction data to the payment manager host computer. At the end of a transaction, the terminal may print a receipt utilizing the printer that is either housed internally within the POS terminal or housed external to the POS terminal. The POS terminal further communicates with the payment manager host computer to reconcile accounts at the end of a predetermined business cycle (e.g., at the end of each day). Communications between the POS terminal and a host computer may be conducted over any suitable network now known or later developed. As used herein, the term “network” shall include any electronic communications means which incorporates both hardware and software components of such. Exemplary networks or communication channels include a telephone network, an extranet, an intranet, Internet, online communications, satellite communications, off-line communications, wireless communications, transponder communications, local area network (LAN), wide area network (WAN), networked or linked devices, and/or any suitable communication or data input modality.

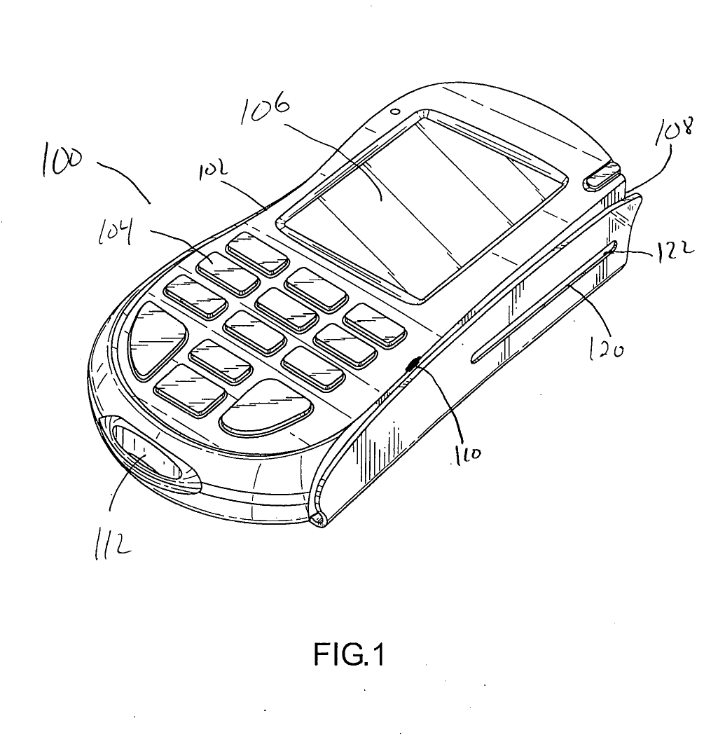

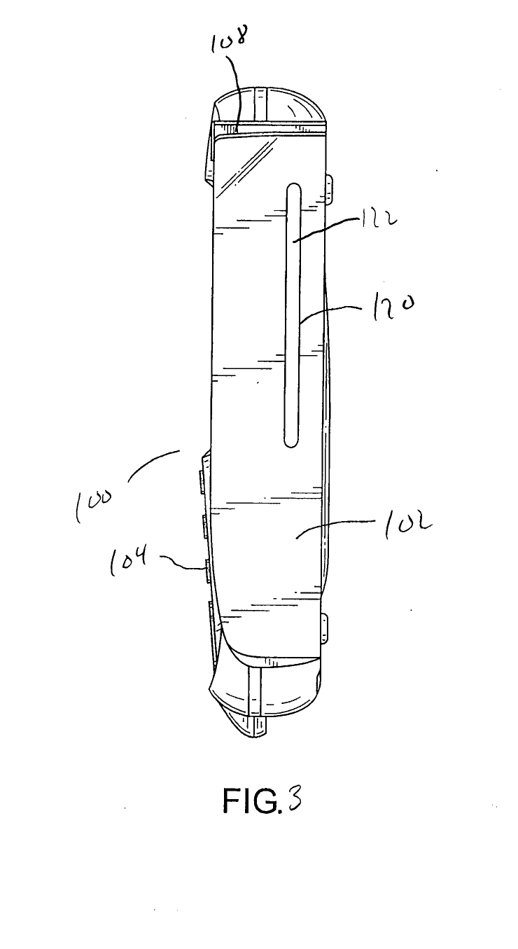

Referring now to FIGS. 1 and 3, an exemplary embodiment of a POS terminal in accordance with the present invention is illustrated including a POS terminal 100 having a housing 102, a key pad 104, an interactive display 106, a magnetic card track 108, and a smart card reader 120. Housing 102 houses various components of POS terminal 100 including basic components not shown here, such as a power supply circuit, internal clock, microcontroller or microprocessor, ROM, RAM, lights, and other suitable hardware for communicating with a host computer, and inputting, processing, transferring or displaying transaction data. It will be appreciated that the shape of the POS terminal is designed such that the POS terminal is easily held in either hand, when in portrait orientation or in landscape portrait.

In an alternative embodiment of the present inventions, the numbers and characters on the keys of pad 104 can be printed at an angle, such as 45 degrees, so that the keys can be viewable and read in either portrait or landscape orientation.

Housing 102 includes magnetic card track 108 formed therein and a smart card reader 120. Other embodiments of the present invention may utilize various combinations of magnetic card tracks, smart card readers and/or contactless card readers. Track 108 includes two sidewalls for guiding a user's transaction card to facilitate extraction of card data from a magnetic stripe on the card.

In operation, POS terminal 100 may display transaction information utilizing interactive screen 106. During the transaction, information may be displayed in a portrait orientation with key pad 104 at the bottom of the POS terminal. When it is time to capture a signature on the POS terminal, a mode button or other indicator may be used to rotate the display into a landscape orientation with key pad 104 either to the left or right of screen 106. When the mode is changed to landscape orientation, terminal software running on the electronic transaction circuits changes the display so that information is displayed on screen 106 in a landscape orientation. This will result in an electronic signature capture screen that can be displayed in either a portrait orientation or a landscape orientation at the touch of a button. It will be appreciated that this allows more room for the user to electronically sign their signature, thus providing for a more compact and portable POS terminal. The design of POS terminal 100 is such that the POS terminal may easily be held in the left or right hand when the POS terminal is in landscape orientation. This facilitates the electronic screen capture and allows both left and right handed users to easily hold the POS terminal while electronically signing their signature. After the signature is captured on the POS terminal, the POS terminal may transmit the transaction information to a POS terminal printer such that a paper receipt may be printed.

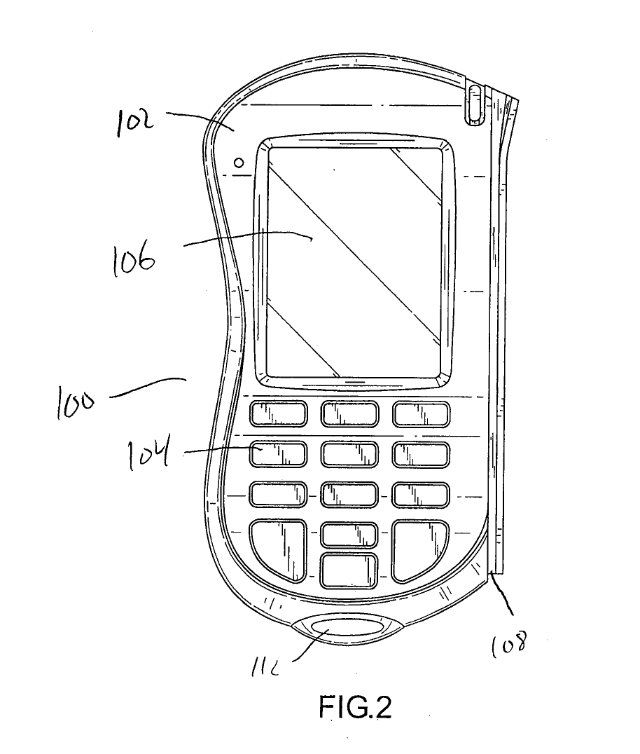

With reference to FIG. 2, housing 102 may include a lanyard opening 112 for connecting a lanyard or similar cord to housing 102. In this manner, a user may carry the POS terminal on their belt, backpack, and the like. In accordance with one embodiment of the present invention, housing 102 may comprise a zinc alloy chassis, resulting in a highly portable, compact POS terminal. In addition, modular or peripheral devices may connect to housing 102, either via a socket or through a wireless connection (not illustrated). Exemplary modular peripheral devices include printers, contactless transaction instrument readers, radio frequency readers, infrared and wireless communications devices, supplemental magnetic stripe readers, PIN keypads, bar code scanners, printers, modems, telephone handsets, biometric scanners, voice command input devices and the like. Similarly, any peripheral device or capability now known or later developed may be integrated into or associated with POS terminal 100. Additionally, housing 102 may include features such as a latch, clip, or slot to facilitate docking, tabletop, pedestal or stand mounting.

In accordance with one embodiment of the present invention, keypad 104 comprises an alphanumeric keypad including keys numbered zero through nine for entry of PIN numbers. Keypad 104 may also include any number of function keys, such as, for example, keys for canceling a transaction, specifying the type of transaction instrument, selecting whether to print a receipt, confirming a charge amount, or for any other relevant feature. Alphanumeric and/or function keys on keypad 104 may be separately movable as with a conventional keyboard, or may be displayed on an interactive surface that responds to pressure, static, or any other suitable user input or action. In accordance with an embodiment of the present inventions, the numbers and characters on the keys of pad 104 can be printed at an angle, such as 45 degrees, so that the keys can be viewable and read in either portrait or landscape orientation.

In accordance with an embodiment of the present invention, keypad 104 is integrated into interactive display 106 as a series of on-screen interactive icons. In accordance with one aspect of the present invention, the interactive icons may be displayed at an angle, such as 45 degrees, so that the icons may be read and easily identified in either portrait or landscape orientation. Exemplary function keys or icons include: cancel, enter, clear, print, reset, power, debit, credit, cash back, additional transaction selection, preset dollar amounts for cash back, and the like.

With continued reference to the embodiment shown in FIGS. 1-3, interactive display 106 serves to display transaction information and also receives user input such as a customer's signature. Various embodiments include electronic signature capture, enabling user's to electronically authorize a transaction by passing a stylus or pen over the display much the same as signing a conventional paper receipt. Replaceable screen protectors protect display 106 from wear by the stylus. Display 106 may present advertising or interactive messages in portrait and landscape formats, with such flashing or moving messages notifying users of merchant membership programs, sales, upcoming events and the like.

In one embodiment of the invention, a transceiver disposed in POS terminal 100 and associated programming modules support wireless communication between POS terminal 100 and a host computer. This wireless communication enables the POS terminal to be portable and even held in a user's hand. The user can carry the POS terminal with them as they carry out their business.

One embodiment of the invention supports age and identity verification by extracting user data from a user's transaction instrument, requesting authentication input, and verifying the user data and authentication input with user data stored on the host system of the transaction instrument issuer. Age and identity verification may likewise be performed using any appropriate transaction instrument data, host system data or user supplied data.

One embodiment of the invention supports payroll check and government check reading and/or cashing. For example, the POS terminal facilitates the capture of routing and account numbers, and any other relevant information from bar codes or other machine readable indicia printed or otherwise accessible on such checks. Thus, a consumer may present such checks for immediate electronic verification and drawing of funds from the check issuer's account for use in payment at a POS terminal. In embodiments that include a cash return device, a consumer may receive any remaining balance of the check value as cash.

In one embodiment of the invention, IP and/or USB ports enable connectivity of the POS terminal with a docking station, printer device, keyboard, personal computer, or with additional POS terminals. Additionally, the POS terminal may support both Ethernet and modem connectivity capabilities. Redundant communications connectivity capabilities serve to reduce or eliminate the impact of temporary network failures by automatically reestablishing communications with a host system using a backup communications channel. For example, if a local internet network hub fails, the POS automatically dials the appropriate host system using a back-up modem. Additional wireless communication capabilities enable portable use of the POS terminal. For example, a salesperson may carry a wireless POS terminal on his or her belt for assisting customer's with showroom purchases without the need to relocate to a cashier's desk

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the present invention is accordingly to be limited by nothing other than the appended claims, in which reference to an element in the singular is not intended to mean “one and only one” unless explicitly so stated, but rather “one or more.” Further, no element described herein is required for the practice of the invention unless expressly described as “essential” or “critical.”

What is claimed is:

1. A point of service terminal comprising:
electronic transaction circuits;
a housing for the electronic transaction circuits;
an interactive display; and
a keypad, wherein the keypad comprises a plurality of keys, wherein each key represents a unique character and wherein each unique character is displayed on one of the keys at an angle such that the character is viewable in a portrait orientation and a landscape orientation.

2. The point of service terminal of claim 1, wherein each unique character is displayed on one of the keys at a forty five degree angle.

3. The point of service terminal of claim 1, wherein the electronic transaction circuits are configured to display an electronic signature capture screen in the portrait orientation and the landscape orientation.

4. A point of service terminal comprising:
electronic transaction circuits;
a housing for the electronic transaction circuits; and
an interactive display, wherein the interactive display is configured to display a plurality of interactive on-screen icons, wherein each icon is displayed at an angle such that the character is viewable in a portrait orientation and a landscape orientation.

5. The point of service terminal of claim 4, wherein each icon is displayed at a forty five degree angle such that the character is viewable in the portrait orientation and the landscape orientation.

6. A method of capturing an electronic signature, wherein the method comprises:
displaying an electronic signature capture screen on an interactive display in a portrait orientation;
pushing a mode button; and
displaying the electronic signature capture screen text on the interactive display in a landscape orientation.
